(19) United States
(12) Patent Application Publication
(10) Pub. No.: US 2020/0149907 A1
(43) Pub. Date: May 14, 2020

(54) VEHICULAR APPARATUS, SYSTEMS, AND METHODS FOR DETECTING, IDENTIFYING, IMAGING, AND MAPPING NOISE SOURCES

(71) Applicant: TOYOTA MOTOR NORTH AMERICA, INC., Plano, TX (US)

(72) Inventor: Shintaro Iwaasa, Frisco, TX (US)

(21) Appl. No.: 16/184,559

(22) Filed: Nov. 8, 2018

(51) Int. Cl. G01C 21/34; G07C 5/00; G07C 5/06; G08G 1/0967; G01C 21/36

(52) U.S. Cl. CPC G01C 21/3461; G07C 5/008; G01C 21/3691; G08G 1/096775; G07C 5/06

(57) ABSTRACT

Vehicular apparatus, systems, and methods for detecting, identifying, imaging, and mapping ambient noise sources. One such generalized method includes detecting, using a microphone of a first vehicle, ambient noise while the first vehicle is parked and/or navigated along a first route. Using a control unit of the first vehicle, an anomalous characteristic exhibited by the detected ambient noise is identified. A camera of the first vehicle captures an image of a source of the identified anomalous characteristic of the detected ambient noise. A global positioning system of the first vehicle identifies a location along the first route at which the detected ambient noise exhibited the anomalous characteristic. Data relating to the identified anomalous characteristic, the identified location, and/or the captured image is communicated to a central server. The identified anomalous characteristic, the identified location, and/or the captured image may be mapped onto a noise map stored on the central server.

### TECHNICAL FIELD

The present disclosure relates generally to vehicular noise detection and, more particularly, to vehicular apparatus, systems, and methods for detecting, identifying, imaging, and mapping ambient noise sources.

### BACKGROUND

Many current vehicles produce very little noise in operation, making the interior cabins of such vehicles especially susceptible to noise disturbance from outside sources. The source and location of such a noise disturbances is often unknown to the driver/passengers of a particular vehicle until the vehicle is located within the vicinity of the source, at which point it is too late to avoid the noise disturbance. Accordingly, it would be desirable to improve the driver/passenger experience (e.g., in autonomous or non-autonomous vehicles) and/or identify noise-generated events that trigger the vehicle to capture additional information, such as images of an exterior environment of the vehicle, especially when the source of the noise disturbance involves damage to the vehicle (e.g., for example, scratches and/or metal deformation caused by a collision). Therefore, what is needed is an apparatus, system, or method that addresses one or more of the foregoing issues, and/or one or more other issues.

### BRIEF DESCRIPTION OF THE DRAWINGS

FIG. 1 is a diagrammatic illustration of a vehicular apparatus capable of detecting, identifying, imaging, and mapping ambient noise sources, according to one or more embodiments of the present disclosure.

FIG. 2 is a detailed diagrammatic view of the vehicular apparatus of FIG. 1, according to one or more embodiments of the present disclosure.

FIG. 3 is a diagrammatic illustration of a vehicular system including at least the vehicular apparatus of FIGS. 1 and 2, according to one or more embodiments of the present disclosure.

FIG. 4 is a flow diagram of a method for implementing one or more embodiments of the present disclosure.

FIG. 5 is a diagrammatic illustration of a computing node for implementing one or more embodiments of the present disclosure.

### SUMMARY

The present disclosure provides vehicular apparatus, systems, and methods for detecting, identifying, imaging, and mapping ambient noise sources. One such generalized method includes detecting, using a microphone of a first vehicle, ambient noise while the first vehicle is parked and/or navigated along a first route. The detected ambient noise is communicated from the microphone to a control unit of the first vehicle. Using the control unit of the first vehicle, an anomalous characteristic exhibited by the detected ambient noise is identified. Finally, data relating to the identified anomalous characteristic is communicated from the control unit of the first vehicle to a central server.

One such generalized system includes a first vehicle including a control unit and a microphone, wherein the microphone is adapted to detect ambient noise while the first vehicle is parked and/or navigated along a first route, wherein the detected ambient noise is adapted to be communicated from the microphone to the control unit of the first vehicle, and wherein the control unit is adapted to identify an anomalous characteristic exhibited by the detected ambient noise. The system further includes a central server to which data relating to the identified anomalous characteristic is adapted to be communicated from the control unit of the first vehicle.

One such generalized apparatus includes a non-transitory computer readable medium; and a plurality of instructions stored on the non-transitory computer readable medium and executable by one or more processors. The plurality of instructions include instructions that, when executed, cause the one or more processors to detect, using a microphone of a first vehicle, ambient noise while the first vehicle is parked and/or navigated along a first route. The plurality of instructions also include instructions that, when executed, cause the one or more processors to communicate the detected ambient noise from the microphone to a control unit of the first vehicle. The plurality of instructions also include instructions that, when executed, cause the one or more processors to identify, using the control unit of the first vehicle, an anomalous characteristic exhibited by the detected ambient noise. Finally, the plurality of instructions also include instructions that, when executed, cause the one or more processors to communicate data relating to the identified anomalous characteristic from the control unit of the first vehicle to a central server.

### DETAILED DESCRIPTION

The invention disclosure is generally directed to a vehicle noise capture system. In particular, a vehicle is equipped with one or more microphone detectors that obtain external and/or internal noise/audio data, such as decibel levels, while the vehicle is in operation (driving) and/or stationary. The vehicle noise capture system uses the obtained external and/or internal noise/audio data to: improve driver/passenger experience (e.g., in autonomous or non-autonomous vehicles); and/or identify noise-generated events that trigger the vehicle to capture additional information, such as images of an exterior environment of the vehicle.

In the case of improving the driver/passenger experience, a communication module of the vehicle uploads the external noise/audio data via towers and/or a base station to a central database of the vehicle noise capture system. The vehicle noise capture system normalizes the external noise/audio data (for example, the decibel levels) for particular areas/locations and generate a noise map that models, and in some implementations, estimates, normalized noise for the particular areas/locations. The noise map identifies areas/locations having higher than desirable noise levels (for example, when passengers are resting or sleeping) and navigate an autonomous vehicle away from such areas based on the noise map. Vehicles upload the external noise/audio data in real-time, such that the vehicle noise capture system is able to identify when an area or location is experiencing a noise spike and navigate autonomous vehicles around the area or location.

For example, where a city street is under construction, the city street may be particularly noisy on a particular day, such as when the construction involves jackhammering. Because the vehicle noise capture system receives noise/audio data from various vehicles in real-time, the vehicle noise capture system identifies a noise spike on the city street on the particular day based on its noise map and direct other vehicles along alternative city streets to avoid the noisy city street. In some implementations, an autonomous or non-autonomous vehicle driving a route that includes the noisy city street may receive data at its communication module instructing its navigation system to find an alternative route that avoids the noisy city street. The vehicle noise capture system thus enables autonomous (e.g., people sleeping or resting in autonomous vehicles) and/or non-autonomous vehicles to have less disruption from external noise.

In the case of identifying noise-generated triggering events, the vehicle noise capture system monitors exterior and/or interior decibel levels and trigger actions when the exterior and/or interior decibel levels exceed a threshold. Since the exterior and/or interior decibel levels will increase when the vehicle is damaged (for example, scratches and/or metal deformation caused by a collision), the vehicle noise capture system detects that the exterior and/or interior decibel levels have exceeded a threshold and trigger action, such as activating cameras disposed about the vehicle to capture images/photographs.

For example, a first vehicle may be parked in a parking lot. When a second vehicle enters the parking lot and bumps into the first vehicle, microphone detectors on the first vehicle will record an increase (or spike) in ambient decibel levels. A vehicle noise capture system of the first vehicle detects the spike in ambient decibel levels and triggers the first vehicle to take action. For example, the vehicle noise capture system activates cameras disposed about the first vehicle to capture images of the exterior environment around the vehicle. The images can be used to identify what caused the spike in ambient decibel levels. In some implementations, the images can be used to identify the second vehicle.

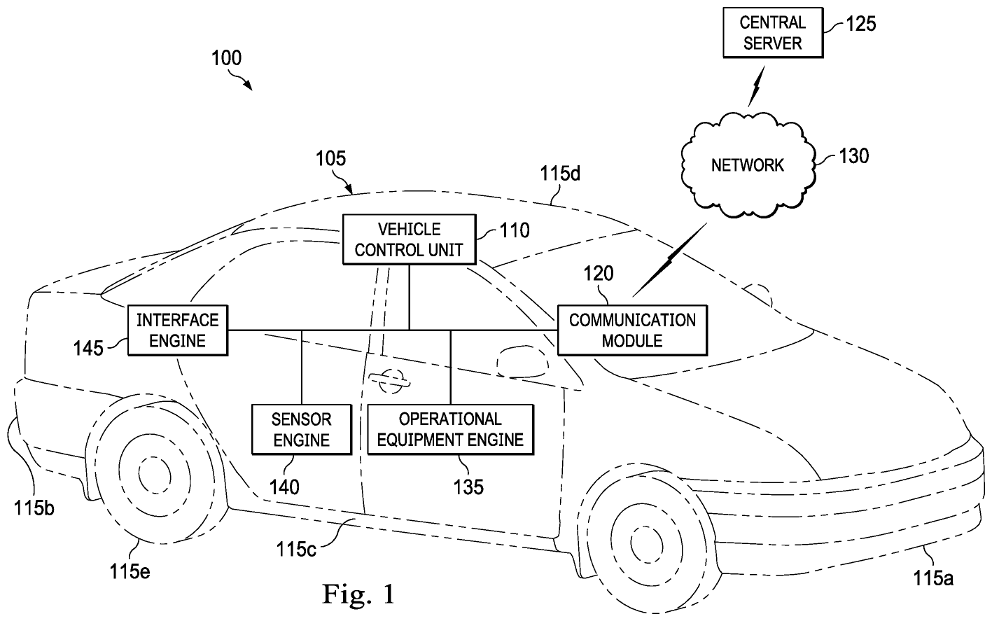

Referring to FIG. 1, in an embodiment, a vehicular apparatus for detecting, identifying, imaging, and mapping ambient noise sources is generally referred to by the reference numeral 100 and includes a vehicle 105, such as an automobile, and a vehicle control unit 110 located on the vehicle 105. The vehicle 105 may include a front portion 115a (including a front bumper), a rear portion 115b (including a rear bumper), a right side portion 115c (including a right front quarter panel, a right front door, a right rear door, and a right rear quarter panel), a left side portion 115d (including a left front quarter panel, a left front door, a left rear door, and a left rear quarter panel), and wheels 115e. A communication module 120 is operably coupled to, and adapted to be in communication with, the vehicle control unit 110. The communication module 120 is adapted to communicate wirelessly with a central server 125 via a network 130 (e.g., a 3G network, a 4G network, a 5G network, a Wi-Fi network, an ad hoc network, or the like).

An operational equipment engine 135 is operably coupled to, and adapted to be in communication with, the vehicle control unit 110. A sensor engine 140 is also operably coupled to, and adapted to be in communication with, the vehicle control unit 110. The sensor engine 140 is adapted to monitor various components of, for example, the operational equipment engine 135 and/or the surrounding environment, as will be described in further detail below. An interface engine 145 is also operably coupled to, and adapted to be in communication with, the vehicle control unit 110. In addition to, or instead of, being operably coupled to, and adapted to be in communication with, the vehicle control unit 110, the communication module 120, the operational equipment engine 135, the sensor engine 140, and/or the interface engine 145 may be operably coupled to, and adapted to be in communication with, one another via wired or wireless communication (e.g., via an in-vehicle network). In some embodiments, as in FIG. 1, the vehicle control unit 110 is adapted to communicate with the communication module 120, the operational equipment engine 135, the sensor engine 140, and the interface engine 145 to at least partially control the interaction of data with and between the various components of the vehicular apparatus 100.

The term “engine” is meant herein to refer to an agent, instrument, or combination of either, or both, agents and instruments that may be associated to serve a purpose or accomplish a task-agents and instruments may include sensors, actuators, switches, relays, power plants, system wiring, computers, components of computers, programmable logic devices, microprocessors, software, software routines, software modules, communication equipment, networks, network services, and/or other elements and their equivalents that contribute to the purpose or task to be accomplished by the engine. Accordingly, some of the engines may be software modules or routines, while others of the engines may be hardware and/or equipment elements in communication with the vehicle control unit 110, the communication module 120, the central server 125, and/or the network 130.

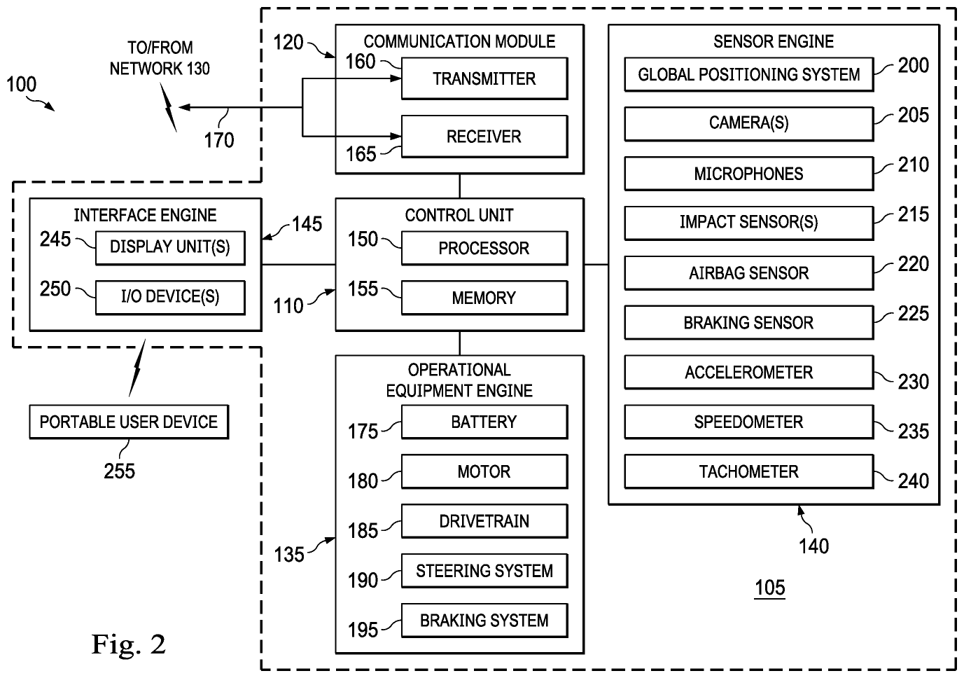

Referring to FIG. 2, a detailed diagrammatic view of the vehicular apparatus 100 of FIG. 1 is illustrated. As shown in FIG. 2, the vehicle control unit 110 includes a processor 150 and a memory 155. In some embodiments, as in FIG. 2, the communication module 120, which is operably coupled to, and adapted to be in communication with, the vehicle control unit 110, includes a transmitter 160 and a receiver 165. In some embodiments, one or the other of the transmitter 160 and the receiver 165 may be omitted according to the particular application for which the communication module 120 is to be used. In some embodiments, the transmitter 160 and the receiver 165 are combined into a transceiver capable of both sending and receiving wireless signals. In any case, the transmitter 160 and the receiver 165 are adapted to send/receive data to/from the network 130, as indicated by arrow(s) 170.

In some embodiments, as in FIG. 2, the operational equipment engine 135, which is operably coupled to, and adapted to be in communication with, the vehicle control unit 110, includes a plurality of devices configured to facilitate driving of the vehicle 105. In this regard, the operational equipment engine 135 may be designed to exchange communication with the vehicle control unit 110, so as to not only receive instructions, but to provide information on the operation of the operational equipment engine 135. For example, the operational equipment engine 135 may include a vehicle battery 175, a motor 180 (e.g., electric or combustion), a drivetrain 185, a steering system 190, and a braking system 195. The vehicle battery 175 provides electrical power to the motor 180, which motor 180 drives the wheels 115e of the vehicle 105 via the drivetrain 185. In some embodiments, in addition to providing power to the motor 180, the vehicle battery 175 provides electrical power to other component(s) of the operational equipment engine 135, the vehicle control unit 110, the communication module 120, the sensor engine 140, the interface engine 145, or any combination thereof.

In some embodiments, as in FIG. 2, the sensor engine 140, which is operably coupled to, and adapted to be in communication with, the vehicle control unit 110, includes devices such as sensors, meters, detectors, or other devices configured to measure or sense a parameter related to a driving operation of the vehicle 105, as will be described in further detail below. For example, the sensor engine 140 may include a global positioning system 200, vehicle camera(s) 205, vehicle microphone(s) 210, vehicle impact sensor(s) 215, an airbag sensor 220, a braking sensor 225, an accelerometer 230, a speedometer 235, a tachometer 240, or any combination thereof. The sensors or other detection devices are generally configured to sense or detect activity, conditions, and circumstances in an area to which the device has access. Sub-components of the sensor engine 140 may be deployed at any operational area where readings regarding the driving of the vehicle 105 may be taken. Readings from the sensor engine 140 are fed back to the vehicle control unit 110. The reported data may include sensed data, or may be derived, calculated, or inferred from the sensed data. The vehicle control unit 110 may send signals to the sensor engine 140 to adjust the calibration or operating parameters of the sensor engine 140 in accordance with a control program in the vehicle control unit 110. The vehicle control unit 110 is adapted to receive and process data from the sensor engine 140 or from other suitable source(s), and to monitor, store (e.g., in the memory 155), and/or otherwise process (e.g., using the processor 150) the received data.

The global positioning system 200 is adapted to track the location of the vehicle 105 and to communicate the location information to the vehicle control unit 110. The vehicle camera(s) 205 are adapted to monitor the vehicle 105's surroundings and to communicate image data to the vehicle control unit 110. The vehicle microphone(s) 210 are adapted to monitor the vehicle 105's surroundings and to communicate noise data to the vehicle control unit 110. Upon reception of the noise data from the vehicle microphone(s) 210, the vehicle control unit 110 is adapted to identify any anomalous characteristics exhibited by the detected ambient noise. In some embodiments, the anomalous characteristic of the detected ambient noise is produced from a surface of the vehicle 105 being damaged. In some embodiments, the anomalous characteristic of the detected ambient noise is produced from a decibel level of the detected ambient noise exceeding a threshold level. However, the anomalous characteristic of the detected ambient noise may be any characteristic of the ambient noise predetermined by the control unit 110 (i.e., programming) to be detrimental to the driver/passenger experience (e.g., in autonomous or non-autonomous vehicles) and/or indicating damage to the vehicle 105.

The vehicle impact sensor(s) 215 are adapted to detect an impact of the vehicle with another vehicle or object, and to communicate the impact information to the vehicle control unit 110. In some embodiments, the vehicle impact sensor(s) 215 is or includes a G-sensor. In some embodiments, the vehicle impact sensor(s) 215 is or includes microphone(s) (e.g., the microphone(s) 210). In some embodiments, the vehicle impact sensor(s) 215 include multiple vehicle impact sensors, respective ones of which may be incorporated into the front portion 115a (e.g., the front bumper), the rear portion 115b (e.g., the rear bumper), the right side portion 115c (e.g., the right front quarter panel, the right front door, the right rear door, and/or the right rear quarter panel), and/or the left side portion 115d (e.g., the left front quarter panel, the left front door, the left rear door, and/or the left rear quarter panel) of the vehicle 105. The airbag sensor 220 is adapted to activate and/or detect deployment of the vehicle 105's airbag(s) and to communicate the airbag deployment information to the vehicle control unit 110. The braking sensor 225 is adapted to monitor usage of the vehicle 105's braking system 195 (e.g., an antilock braking system 195) and to communicate the braking information to the vehicle control unit 110.

The accelerometer 230 is adapted to monitor acceleration of the vehicle 105 and to communicate the acceleration information to the vehicle control unit 110. The accelerometer 230 may be, for example, a two-axis accelerometer 230 or a three-axis accelerometer 230. In some embodiments, the accelerometer 230 is associated with an airbag of the vehicle 105 to trigger deployment of the airbag. The speedometer 235 is adapted to monitor speed of the vehicle 105 and to communicate the speed information to the vehicle control unit 110. In some embodiments, the speedometer 235 is associated with a display unit of the vehicle 105 such as, for example, a display unit of the interface engine 145, to provide a visual indication of vehicle speed to a driver of the vehicle 105. The tachometer 240 is adapted to monitor the working speed (e.g., in revolutions-per-minute) of the vehicle 105's motor 180 and to communicate the angular velocity information to the vehicle control unit 110. In some embodiments, the tachometer 240 is associated with a display unit of the vehicle 105 such as, for example, a display unit of the interface engine 145, to provide a visual indication of the motor 180's working speed to the driver of the vehicle 105.

In some embodiments, as in FIG. 2, the interface engine 145, which is operably coupled to, and adapted to be in communication with, the vehicle control unit 110, includes at least one input and output device or system that enables a user to interact with the vehicle control unit 110 and the functions that the vehicle control unit 110 provides. For example, the interface engine 145 may include a display unit 245 and an input/output (“I/O”) device 250. The display unit 245 may be, include, or be part of multiple display units. For example, in some embodiments, the display unit 245 may include one, or any combination, of a central display unit associated with a dash of the vehicle 105, an instrument cluster display unit associated with an instrument cluster of the vehicle 105, and/or a heads-up display unit associated with the dash and a windshield of the vehicle 105; accordingly, as used herein the reference numeral 245 may refer to one, or any combination, of the display units. The I/O device 250 may be, include, or be part of a communication port (e.g., a USB port), a Bluetooth communication interface, a touch-screen display unit, soft keys associated with a dash, a steering wheel, or another component of the vehicle 105, and/or similar components. Other examples of sub-components that may be part of the interface engine 145 include, but are not limited to, audible alarms, visual alerts, tactile alerts, telecommunications equipment, and computer-related components, peripherals, and systems.

In some embodiments, a portable user device 255 belonging to an occupant of the vehicle 105 may be coupled to, and adapted to be in communication with, the interface engine 145. For example, the portable user device 255 may be coupled to, and adapted to be in communication with, the interface engine 145 via the I/O device 250 (e.g., the USB port and/or the Bluetooth communication interface). In an embodiment, the portable user device 255 is a handheld or otherwise portable device which is carried onto the vehicle 105 by a user who is a driver or a passenger on the vehicle 105. In addition, or instead, the portable user device 255 may be removably connectable to the vehicle 105, such as by temporarily attaching the portable user device 255 to the dash, a center console, a seatback, or another surface in the vehicle 105. In another embodiment, the portable user device 255 may be permanently installed in the vehicle 105. In some embodiments, the portable user device 255 is, includes, or is part of one or more computing devices such as personal computers, personal digital assistants, cellular devices, mobile telephones, wireless devices, handheld devices, laptops, audio devices, tablet computers, game consoles, cameras, and/or any other suitable devices. In several embodiments, the portable user device 255 is a smartphone such as, for example, an iPhone® by Apple Inc.

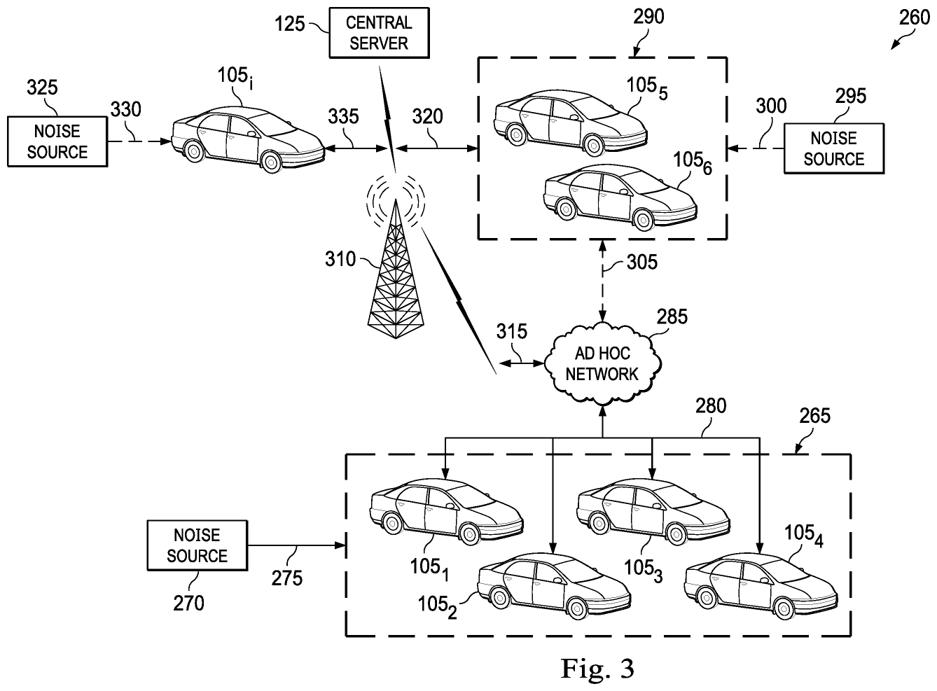

Referring to FIG. 3, in an embodiment, a vehicular system for detecting, identifying, imaging, and mapping ambient noise sources is generally referred to by the reference numeral 260 and includes several components of the vehicular apparatus 100. More particularly, the vehicular system 260 includes a plurality of vehicles substantially identical to the vehicle 105 of the vehicular apparatus 100, which vehicles are given the same reference numeral 105, except that a subscript 1, 2, 3, 4, 5, 6, or i is added to each as a suffix. In some embodiments, as in FIG. 3, the vehicular system 260 includes the vehicles 105₁₋₄, which form a vehicle group 265 whose current location is in the vicinity of a noise source 270. The noise source 270 emits noise toward the vehicle group 265, as indicated by arrow 275. Since the vehicle group 265 is located in the vicinity of the noise source 270, one or more of the respective sensor engines of the vehicles 105₁₋₄ are adapted to detect the noise 275 emitted by the noise source 270. For example, the noise 275 may be detected using the vehicle microphone(s) of one or more of the vehicles 105₁₋₄. In some embodiments, in response to the detection of the noise 275 by the vehicles 105₁₋₄, the vehicle camera(s) of one or more of the vehicles 105₁₋₄ may be adapted to capture an image of the noise source 270. In addition, the vehicles 105₁₋₄ may be adapted to communicate with one another via their respective communication modules, as indicated by arrow(s) 280, so as to form an ad hoc network 285.

In some embodiments, as in FIG. 3, the vehicular system 260 also includes the vehicles 105₅₋₆, which are not located in the vicinity of the noise source 270, but instead form a vehicle group 290 whose intended route intersects a location in the vicinity of the noise source 270. Although not located in the vicinity of the noise source 270, the vehicles 105₅₋₆ may instead be located in the vicinity of a noise source 295, which noise source 295 emits noise toward the vehicles 105₅₋₆, as indicated by arrow 300. Since the vehicles 105₅₋₆ are located in the vicinity of the noise source 295, the respective sensor engines of the vehicles 105₅₋₆ are adapted to detect the noise 300 emitted by the noise source 295. For example, the noise 300 may be detected using the respective vehicle microphone(s) of the vehicles 105₅₋₆. In some embodiments, in response to the detection of the noise 300 by the vehicles 105₅₋₆, the vehicle camera(s) of the vehicles 105₅₋₆ may be adapted to capture an image of the noise source 295.

If the physical distance between the vehicle group 290 and the vehicle group 265 is close enough to permit direct vehicle-to-vehicle communication therebetween (e.g., within range of the ad hoc network 285), one or more of the vehicles 105₅₋₆ may be adapted to communicate with one or more of the vehicles 105₁₋₄ via their respective communication modules, as indicated by arrow 305, so as to form part of the ad hoc network 285. In contrast, if the physical distance between the vehicle group 290 and the vehicle group 265 is not close enough to permit direct vehicle-to-vehicle communication therebetween (e.g., not within range of the ad hoc network 285), one or more of the vehicles 105₁₋₄ forming the ad hoc network 285 may be further adapted to communicate via another communication protocol such as, for example, a cellular network 310, as indicated by arrow 315. In such embodiments, one or more of the vehicles 105₅₋₆ is also adapted to communicate via the cellular network 310, as indicated by arrow 320. Moreover, in those embodiments in which the physical distance between the vehicle group 290 and the vehicle group 265 is not close enough to permit direct vehicle-to-vehicle communication therebetween (e.g., not within range of the ad hoc network 285), the vehicles 105₅₋₆ in the vehicle group 290 may be adapted to communicate with one another via their respective communication modules so as to form a separate ad hoc network (not shown in FIG. 3).

In some embodiments, as in FIG. 3, the vehicular system 260 also includes the vehicle 105ᵢ, which is neither located in the vicinity of the noise source 270 or 295, nor does it have a route that intersects a location in the vicinity of the noise source 270 or 295. Although not located in the vicinity of the noise source 270 or 295, the vehicle 105ᵢ may instead be located in the vicinity of a noise source 325, which noise source 325 emits noise toward the vehicle 105, as indicated by arrow 330. Since the vehicle 105ᵢ is located in the vicinity of the noise source 325, the sensor engine of the vehicle 105ᵢ is adapted to detect the noise 330 emitted by the noise source 325. For example, the noise 330 may be detected using the vehicle microphone(s) of the vehicle 105ᵢ. In some embodiments, in response to the detection of the noise 330 by the vehicle 105ᵢ, the vehicle camera(s) of the vehicles 105ᵢ may be adapted to capture an image of the noise source 325. In addition, the vehicle 105ᵢ may be adapted to communicate via the cellular network 310, as indicated by arrow 335.

In some embodiments, as in FIG. 3, the vehicular system 260 also includes the central server 125, which is adapted to send and/or receive data to/from one or more of the vehicles 105₁₋ᵢ via the ad hoc network 285, the cellular network 310, the separate ad hoc network (not shown in FIG. 3) formed by and between the vehicles 105₅₋₆, or any combination thereof. The central server 125 is adapted to map, based on data received from one or more of the vehicles 105₁₋ᵢ, the locations of one or more of the noise sources 270, 295, and/or 325 onto a noise map stored on the central server 125. In some embodiments, the central server 125 is further adapted to link images of one or more of the respective noise sources 270, 295, and/or 325 captured by the vehicle camera(s) of the one or more of the vehicles 105₁₋ᵢ to the noise map. In some embodiments, the central server 125 is further adapted to communicate data relating to at least a portion of the noise map onto which the locations of the one or more of the noise sources 270, 295, and/or 325 are mapped to another one of the vehicles 105₁₋ᵢ. As a result, the global positing system(s) of the another one of the vehicles 105₁₋ᵢ can be used to navigate the another one of the vehicles 105₁₋ᵢ along a route that avoids locations in the vicinity of the one or more of the noise sources 270, 295, and/or 325.

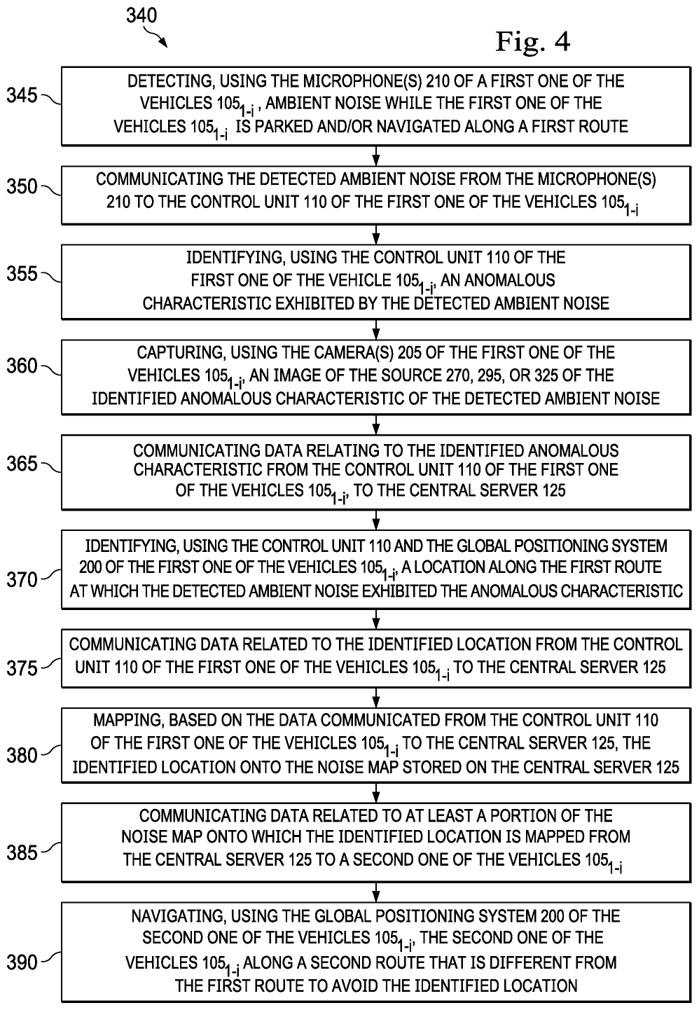

Referring to FIG. 4, a method of using the vehicular system 260 for detecting, identifying, imaging, and mapping ambient noise sources is generally referred to by the reference numeral 340. The method 340 is executed in response to one or more of the noise sources 270, 295, and/or 325 emitting noise, as indicated by the arrows 275, 300, and 330 respectively. The method 340 includes at a step 345, detecting, using the microphone(s) 210 of a first one of the vehicles 105₁₋ᵢ, ambient noise while the first one of the vehicles 105₁₋ᵢ is parked and/or navigated along a first route. At a step 350, the detected ambient noise is communicated from the microphone(s) 210 to the control unit 110 of the first one of the vehicles 105₁₋ᵢ. At a step 355, using the control unit 110 of the first one of the vehicle 105₁₋ᵢ, an anomalous characteristic exhibited by the detected ambient noise is identified. In some embodiments of the step 355, the anomalous characteristic of the detected ambient noise is produced from a surface of the first one of the vehicles 105₁₋ᵢ being damaged. In some embodiments of the step 355, the anomalous characteristic of the detected ambient noise is produced from a decibel level of the detected ambient noise exceeding a threshold level. At a step 360, using the camera(s) 205 of the first one of the vehicles 105₁₋ᵢ, an image of the source 270, 295, or 325 of the identified anomalous characteristic of the detected ambient noise is captured. At a step 365, data relating to the identified anomalous characteristic is communicated from the control unit 110 of the first one of the vehicles 105₁₋ᵢ to the central server 125.

At a step 370, using the control unit 110 and the global positioning system 200 of the first one of the vehicles 105₁₋ᵢ, a location along the first route at which the detected ambient noise exhibited the anomalous characteristic is identified. At a step 375, data relating to the identified location is communicated from the control unit 110 of the first one of the vehicles 105₁₋ᵢ to the central server 125. At a step 380, based on the data communicated from the control unit 110 of the first one of the vehicles 105₁₋ᵢ to the central server 125, the identified location is mapped onto the noise map stored on the central server 125. At a step 385, data relating to at least a portion of the noise map onto which the identified location is mapped is communicated from the central server 125 to a second one of the vehicles 105₁₋ᵢ. At a step 390, using the global positioning system 200 of the second one of the vehicles 105₁₋ᵢ, the second one of the vehicles 105₁₋ᵢ is navigated along a second route that is different from the first route to avoid the identified location.

In some embodiments, the operation of the system 260 and/or the execution of the method 340 makes known to the driver/passengers of a particular vehicle the source and location of a noise disturbance before the vehicle is located within the vicinity of the source, at which point it would be too late to avoid the noise disturbance. In some embodiments, the operation of the system 260 and/or the execution of the method 340 improves the driver/passenger experience (e.g., in autonomous or non-autonomous vehicles) by avoiding external noise disturbances. In some embodiments, the operation of the system 260 and/or the execution of the method 340 identifies noise-generated events that trigger the vehicle to capture additional information, such as images of an exterior environment of the vehicle. In some embodiments, the operation of the system 260 and/or the execution of the method 340 identifies noise-generated events that trigger the vehicle to capture additional information, such as images of the source of the noise disturbance (e.g., involving damage to the vehicle such as scratches and/or metal deformation caused by a collision).

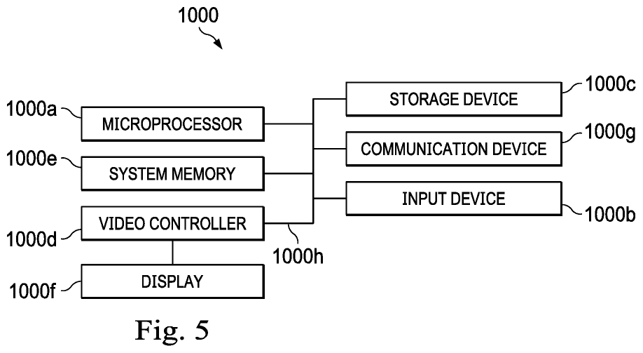

Referring to FIG. 5, in an embodiment, a computing node 1000 for implementing one or more embodiments of one or more of the above-described elements, control units (e.g., 110), apparatus (e.g., 100), systems (e.g., 260), methods (e.g., 340) and/or steps (e.g., 345, 350, 355, 360, 365, 370, 375, 380, 385, and/or 390), or any combination thereof, is depicted. The node 1000 includes a microprocessor 1000a, an input device 1000b, a storage device 1000c, a video controller 1000d, a system memory 1000e, a display 1000f, and a communication device 1000g all interconnected by one or more buses 1000h. In several embodiments, the storage device 1000c may include a floppy drive, hard drive, CD-ROM, optical drive, any other form of storage device or any combination thereof. In several embodiments, the storage device 1000c may include, and/or be capable of receiving, a floppy disk, CD-ROM, DVD-ROM, or any other form of computer-readable medium that may contain executable instructions. In several embodiments, the communication device 1000g may include a modem, network card, or any other device to enable the node 1000 to communicate with other nodes. In several embodiments, any node represents a plurality of interconnected (whether by intranet or Internet) computer systems, including without limitation, personal computers, mainframes, PDAs, smartphones and cell phones.

In several embodiments, one or more of the components of any of the above-described systems include at least the node 1000 and/or components thereof, and/or one or more nodes that are substantially similar to the node 1000 and/or components thereof. In several embodiments, one or more of the above-described components of the node 1000 and/or the above-described systems include respective pluralities of same components.

In several embodiments, a computer system typically includes at least hardware capable of executing machine readable instructions, as well as the software for executing acts (typically machine-readable instructions) that produce a desired result. In several embodiments, a computer system may include hybrids of hardware and software, as well as computer sub-systems.

In several embodiments, hardware generally includes at least processor-capable platforms, such as client-machines (also known as personal computers or servers), and hand-held processing devices (such as smart phones, tablet computers, personal digital assistants (PDAs), or personal computing devices (PCDs), for example). In several embodiments, hardware may include any physical device that is capable of storing machine-readable instructions, such as memory or other data storage devices. In several embodiments, other forms of hardware include hardware sub-systems, including transfer devices such as modems, modem cards, ports, and port cards, for example.

In several embodiments, software includes any machine code stored in any memory medium, such as RAM or ROM, and machine code stored on other devices (such as floppy disks, flash memory, or a CD ROM, for example). In several embodiments, software may include source or object code. In several embodiments, software encompasses any set of instructions capable of being executed on a node such as, for example, on a client machine or server.

In several embodiments, combinations of software and hardware could also be used for providing enhanced functionality and performance for certain embodiments of the present disclosure. In an embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In several embodiments, computer readable mediums include, for example, passive data storage, such as a random access memory (RAM) as well as semi-permanent data storage such as a compact disk read only memory (CD-ROM). One or more embodiments of the present disclosure may be embodied in the RAM of a computer to transform a standard computer into a new specific computing machine. In several embodiments, data structures are defined organizations of data that may enable an embodiment of the present disclosure. In an embodiment, data structure may provide an organization of data, or an organization of executable code.

In several embodiments, any networks and/or one or more portions thereof, may be designed to work on any specific architecture. In an embodiment, one or more portions of any networks may be executed on a single computer, local area networks, client-server networks, wide area networks, internets, hand-held and other portable and wireless devices and networks.

In several embodiments, database may be any standard or proprietary database software. In several embodiments, the database may have fields, records, data, and other database elements that may be associated through database specific software. In several embodiments, data may be mapped. In several embodiments, mapping is the process of associating one data entry with another data entry. In an embodiment, the data contained in the location of a character file can be mapped to a field in a second table. In several embodiments, the physical location of the database is not limiting, and the database may be distributed. In an embodiment, the database may exist remotely from the server, and run on a separate platform. In an embodiment, the database may be accessible across the Internet. In several embodiments, more than one database may be implemented.

In several embodiments, a plurality of instructions stored on a computer readable medium may be executed by one or more processors to cause the one or more processors to carry out or implement in whole or in part the above-described operation of each of the above-described elements, control units (e.g., 110), apparatus (e.g., 100), systems (e.g., 260), methods (e.g., 340) and/or steps (e.g., 345, 350, 355, 360, 365, 370, 375, 380, 385, and/or 390), and/or any combination thereof. In several embodiments, such a processor may include one or more of the microprocessor 1000a, any processor(s) that are part of the components of the above-described systems, and/or any combination thereof, and such a computer readable medium may be distributed among one or more components of the above-described systems. In several embodiments, such a processor may execute the plurality of instructions in connection with a virtual computer system. In several embodiments, such a plurality of instructions may communicate directly with the one or more processors, and/or may interact with one or more operating systems, middleware, firmware, other applications, and/or any combination thereof, to cause the one or more processors to execute the instructions.

A method has been disclosed. The method generally includes detecting, using a microphone of a first vehicle, ambient noise while the first vehicle is parked and/or navigated along a first route; communicating the detected ambient noise from the microphone to a control unit of the first vehicle; identifying, using the control unit of the first vehicle, an anomalous characteristic exhibited by the detected ambient noise; and communicating data relating to the identified anomalous characteristic from the control unit of the first vehicle to a central server.

The foregoing method embodiment may include one or more of the following elements, either alone or in combination with one another:
Capturing, using a camera of the first vehicle, an image of a source of the identified anomalous characteristic of the detected ambient noise.
The anomalous characteristic of the detected ambient noise is produced from a surface of the first vehicle being damaged.
Identifying, using the control unit and a global positioning system of the first vehicle, a location along the first route at which the detected ambient noise exhibited the anomalous characteristic; and communicating data relating to the identified location from the control unit of the first vehicle to the central server
Mapping, based on the data communicated from the control unit of the first vehicle to the central server, the identified location onto a noise map stored on the central server.
Communicating data relating to at least a portion of the noise map onto which the identified location is mapped from the central server to a second vehicle; and navigating, using a global positing system of the second vehicle, the second vehicle along a second route that is different from the first route to avoid the identified location.
The anomalous characteristic of the detected ambient noise is produced from a decibel level of the detected ambient noise exceeding a threshold level.

A system has been disclosed. The system generally includes a first vehicle including a control unit and a microphone, wherein the microphone is adapted to detect ambient noise while the first vehicle is parked and/or navigated along a first route, wherein the detected ambient noise is adapted to be communicated from the microphone to the control unit of the first vehicle, and wherein the control unit is adapted to identify an anomalous characteristic exhibited by the detected ambient noise; and a central server to which data relating to the identified anomalous characteristic is adapted to be communicated from the control unit of the first vehicle.

The foregoing system embodiment may include one or more of the following elements, either alone or in combination with one another:
The first vehicle further includes a camera adapted to capture an image of a source of the identified anomalous characteristic of the detected ambient noise.
The anomalous characteristic of the detected ambient noise is produced from a surface of the first vehicle being damaged.
The first vehicle further includes a global positioning system; wherein the control unit and the global positioning system of the first vehicle are adapted to identify a location along the first route at which the detected ambient noise exhibited the anomalous characteristic; and wherein data relating to the identified location is adapted to be communicated from the control unit of the first vehicle to the central server.
Based on the data communicated from the control unit of the first vehicle to the central server, the identified location is adapted to be mapped onto a noise map stored on the central server.
The system further includes a second vehicle including a global positioning system; wherein data relating to at least a portion of the noise map onto which the identified location is mapped is adapted to be communicated from the central server to a second vehicle; and wherein the global positing system of the second vehicle is adapted to navigate the second vehicle along a second route that is different from the first route to avoid the identified location.
The anomalous characteristic of the detected ambient noise is produced from a decibel level of the detected ambient noise exceeding a threshold level.

An apparatus has been disclosed. The apparatus generally includes a non-transitory computer readable medium; and a plurality of instructions stored on the non-transitory computer readable medium and executable by one or more processors, the plurality of instructions including: instructions that, when executed, cause the one or more processors to detect, using a microphone of a first vehicle, ambient noise while the first vehicle is parked and/or navigated along a first route; instructions that, when executed, cause the one or more processors to communicate the detected ambient noise from the microphone to a control unit of the first vehicle; instructions that, when executed, cause the one or more processors to identify, using the control unit of the first vehicle, an anomalous characteristic exhibited by the detected ambient noise; and instructions that, when executed, cause the one or more processors to communicate data relating to the identified anomalous characteristic from the control unit of the first vehicle to a central server.

The foregoing apparatus embodiment may include one or more of the following elements, either alone or in combination with one another:
The plurality of instructions further include instructions that, when executed, cause the one or more processors to capture, using a camera of the first vehicle, an image of a source of the identified anomalous characteristic of the detected ambient noise.
The anomalous characteristic of the detected ambient noise is produced from a surface of the first vehicle being damaged.
The plurality of instructions further include: instructions that, when executed, cause the one or more processors to identify, using the control unit and a global positioning system of the first vehicle, a location along the first route at which the detected ambient noise exhibited the anomalous characteristic; and instructions that, when executed, cause the one or more processors to communicate data relating to the identified location from the control unit of the first vehicle to the central server.
The plurality of instructions further include instructions that, when executed, cause the one or more processors to map, based on the data communicated from the control unit of the first vehicle to the central server, the identified location onto a noise map stored on the central server.
The plurality of instructions further include: instructions that, when executed, cause the one or more processors to communicate data relating to at least a portion of the noise map onto which the identified location is mapped from the central server to a second vehicle; and instructions that, when executed, cause the one or more processors to navigate, using a global positing system of the second vehicle, the second vehicle along a second route that is different from the first route to avoid the identified location.
The anomalous characteristic of the detected ambient noise is produced from a decibel level of the detected ambient noise exceeding a threshold level.

It is understood that variations may be made in the foregoing without departing from the scope of the present disclosure.

In some embodiments, the elements and teachings of the various embodiments may be combined in whole or in part in some or all of the embodiments. In addition, one or more of the elements and teachings of the various embodiments may be omitted, at least in part, and/or combined, at least in part, with one or more of the other elements and teachings of the various embodiments.

Any spatial references, such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In some embodiments, while different steps, processes, and procedures are described as appearing as distinct acts, one or more of the steps, one or more of the processes, and/or one or more of the procedures may also be performed in different orders, simultaneously and/or sequentially. In some embodiments, the steps, processes, and/or procedures may be merged into one or more steps, processes and/or procedures.

In some embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although some embodiments have been described in detail above, the embodiments described are illustrative only and are not limiting, and those skilled in the art will readily appreciate that many other modifications, changes and/or substitutions are possible in the embodiments without materially departing from the novel teachings and advantages of the present disclosure. Accordingly, all such modifications, changes, and/or substitutions are intended to be included within the scope of this disclosure as defined in the following claims.

What is claimed is:

1. A method comprising:
detecting, using a microphone of a first vehicle, ambient noise while the first vehicle is parked and/or navigated along a first route;
communicating the detected ambient noise from the microphone to a control unit of the first vehicle;
identifying, using the control unit of the first vehicle, an anomalous characteristic exhibited by the detected ambient noise; and
communicating data relating to the identified anomalous characteristic from the control unit of the first vehicle to a central server.

2. The method of claim 1, further comprising:
capturing, using a camera of the first vehicle, an image of a source of the identified anomalous characteristic of the detected ambient noise.

3. The method of claim 2, wherein the anomalous characteristic of the detected ambient noise is produced from a surface of the first vehicle being damaged.

4. The method of claim 1, further comprising:
identifying, using the control unit and a global positioning system of the first vehicle, a location along the first route at which the detected ambient noise exhibited the anomalous characteristic; and
communicating data relating to the identified location from the control unit of the first vehicle to the central server.

5. The method of claim 4, further comprising:
mapping, based on the data communicated from the control unit of the first vehicle to the central server, the identified location onto a noise map stored on the central server.

6. The method of claim 5, further comprising:
communicating data relating to at least a portion of the noise map onto which the identified location is mapped from the central server to a second vehicle; and
navigating, using a global positing system of the second vehicle, the second vehicle along a second route that is different from the first route to avoid the identified location.

7. The method of claim 4, wherein the anomalous characteristic of the detected ambient noise is produced from a decibel level of the detected ambient noise exceeding a threshold level.

8. A system comprising:
a first vehicle including a control unit and a microphone,
wherein the microphone is adapted to detect ambient noise while the first vehicle is parked and/or navigated along a first route,
wherein the detected ambient noise is adapted to be communicated from the microphone to the control unit of the first vehicle, and
wherein the control unit is adapted to identify an anomalous characteristic exhibited by the detected ambient noise; and
a central server to which data relating to the identified anomalous characteristic is adapted to be communicated from the control unit of the first vehicle.

9. The system of claim 8, wherein the first vehicle further includes:
a camera adapted to capture an image of a source of the identified anomalous characteristic of the detected ambient noise.

10. The system of claim 9, wherein the anomalous characteristic of the detected ambient noise is produced from a surface of the first vehicle being damaged.

11. The system of claim 8, wherein the first vehicle further includes a global positioning system;
wherein the control unit and the global positioning system of the first vehicle are adapted to identify a location along the first route at which the detected ambient noise exhibited the anomalous characteristic; and
wherein data relating to the identified location is adapted to be communicated from the control unit of the first vehicle to the central server.

12. The system of claim 11, wherein, based on the data communicated from the control unit of the first vehicle to the central server, the identified location is adapted to be mapped onto a noise map stored on the central server.

13. The system of claim 12, further comprising a second vehicle including a global positioning system;
wherein data relating to at least a portion of the noise map onto which the identified location is mapped is adapted to be communicated from the central server to a second vehicle; and
wherein the global positing system of the second vehicle is adapted to navigate the second vehicle along a second route that is different from the first route to avoid the identified location.

14. The system of claim 11, wherein the anomalous characteristic of the detected ambient noise is produced from a decibel level of the detected ambient noise exceeding a threshold level.

15. An apparatus, comprising:
a non-transitory computer readable medium; and
a plurality of instructions stored on the non-transitory computer readable medium and executable by one or more processors, the plurality of instructions comprising:
instructions that, when executed, cause the one or more processors to detect, using a microphone of a first vehicle, ambient noise while the first vehicle is parked and/or navigated along a first route;
instructions that, when executed, cause the one or more processors to communicate the detected ambient noise from the microphone to a control unit of the first vehicle;
instructions that, when executed, cause the one or more processors to identify, using the control unit of the first vehicle, an anomalous characteristic exhibited by the detected ambient noise; and
instructions that, when executed, cause the one or more processors to communicate data relating to the identified anomalous characteristic from the control unit of the first vehicle to a central server.

16. The apparatus of claim 15, wherein the plurality of instructions further comprise:
instructions that, when executed, cause the one or more processors to capture, using a camera of the first vehicle, an image of a source of the identified anomalous characteristic of the detected ambient noise.

17. The apparatus of claim 2, wherein the anomalous characteristic of the detected ambient noise is produced from a surface of the first vehicle being damaged.

18. The apparatus of claim 15, wherein the plurality of instructions further comprise:
instructions that, when executed, cause the one or more processors to identify, using the control unit and a global positioning system of the first vehicle, a location along the first route at which the detected ambient noise exhibited the anomalous characteristic; and
instructions that, when executed, cause the one or more processors to communicate data relating to the identified location from the control unit of the first vehicle to the central server.

19. The apparatus of claim 18, wherein the plurality of instructions further comprise:
instructions that, when executed, cause the one or more processors to map, based on the data communicated from the control unit of the first vehicle to the central server, the identified location onto a noise map stored on the central server.

20. The apparatus of claim 19, wherein the plurality of instructions further comprise:
instructions that, when executed, cause the one or more processors to communicate data relating to at least a portion of the noise map onto which the identified location is mapped from the central server to a second vehicle; and
instructions that, when executed, cause the one or more processors to navigate, using a global positing system of the second vehicle, the second vehicle along a second route that is different from the first route to avoid the identified location.

21. The apparatus of claim 18, wherein the anomalous characteristic of the detected ambient noise is produced from a decibel level of the detected ambient noise exceeding a threshold level.
